(19) United States
(12) Patent Application Publication
(10) Pub. No.: US 2023/0224935 A1
(43) Pub. Date: Jul. 13, 2023

(54) TRANSMISSION BAND SELECTION USING BATTERY STATUS

(71) Applicant: IPCOM GMBH & CO. KG, Pullach (DE)

(72) Inventors: Maik BIENAS, Schoeppenstedt (DE); Achim LUFT, Braunschweig (DE)

(73) Assignee: IPCOM GMBH & CO. KG, Pullach (DE)

(21) Appl. No.: 18/000,398

(22) PCT Filed: Jun. 23, 2021
(86) PCT No.: PCT/EP2021/067234

§ 371 Date: Dec. 1, 2022

(30) Foreign Application Priority Data
Jun. 24, 2020 (EP) 20181938.0

(51) Int. Cl. H04W 72/51; H04W 72/0453

(52) U.S. Cl. CPC H04W 72/51; H04W 72/0453

(57) ABSTRACT

The present invention provides a method of selecting a frequency band of a mobile communications network in which a user equipment, UE, device is to operate, the method comprising determining a charge status of a rechargeable power supply of the UE device; and dependent on the charge status, generating an indication that the UE device should, taking into account the charge status, preferably be set to operate in a frequency band having a lower attenuation coefficient than a second frequency band in which the UE device could be set to operate in.

The present invention relates to the selection by a user equipment, UE, device or a network entity of a transmission frequency or transmission band dependent on a battery status of the UE device.

A trend of mobile communication is that of a demand for a permanently increasing data rate. One way to satisfy this need, is to use frequency bands for transmission and reception, which are currently unused, at least for mobile communications.

Due to historical reasons and beneficial physical properties, the bands of lower frequencies, e.g. below 3 GHz, are already occupied, either for mobile communication or for other purposes like television and radio broadcasts. To add further bandwidth, 5G will additionally use higher frequency bands of up to 52.6 GHz (cf. 3GPP TS 38.101). These bands will provide large amount of additional bandwidth but will require additional transmit power.

Radio transmissions are affected by signal attenuation. Attenuation is dependent on the carrier frequency and is a main parameter for power consumption of a transmission, as it is compensated by an increased transmission power. Therefore, a careful selection of the carrier frequency can significantly influence the power consumption. On the other side, such higher signal attenuations will provide a mean for interference reduction, as also interfering signals are affected by such attenuations. Devices may benefit from lower interferences on the costs of a higher transmit power.

There is a general effect, that higher frequencies will cause a higher attenuation. In addition, there are certain attenuation peaks at some frequencies, which result from resonances of the molecules in the air, for example there is an attenuation peak at about 24 GHz which is caused by water vapour in the air.

This invention takes into account a dependence of transmit power on a carrier frequency to be used. An assignment of a carrier frequency may, for example, take place at connection setup or periodically.

Currently, mobile radio systems do not take into account the battery state of a mobile device, when assigning a frequency band to it. Therefore, devices with limited remaining battery power may be assigned to a frequency band, which may lead to an unnecessary higher demand of power, even though a more energy efficient band would be available. Additionally, devices without power restrictions, e.g. devices that are connected to a power supply, may be assigned to a power saving frequency band and will therefore reduce the availability for power limited devices.

Known arrangements in which a battery level is taken into account when operating a mobile telephone include those described in US 2017111910 A1, U.S. Pat. No. 9,253,729 B1, WO 2018128730 A1 and KR 20190131899 A. WO 2007080627 A1 describes the selection of an access technology dependent on a battery status. Further known systems include those of EP 3 603 224 A1, EP 3 123 791 A1 and U.S. Pat. No. 10,568,036 B2.

In US 2016/0330692 A1 an arrangement is described in which an electronic device, for example a smartphone, can switch between operating modes with the two modes having differing energy consumption characteristics. The transition can be dependent on a battery charge level. U.S. Pat. No. 6,278,864 B1 describes entering a sleep mode in order to conserve power. US 2010/0093279 A1 concerns a communication device which include a power scan module for detecting received radio wave energy and which is periodically woken.

The present invention provides a method of selecting a frequency band of a mobile communications network in which a user equipment, UE, device is to operate, the method comprising determining a charge status of a rechargeable power supply of the UE device; and dependent on the charge status, generating an indication that the UE device should, taking into account the charge status, preferably be set to operate in a frequency band having a lower attenuation coefficient than a second frequency band in which the UE device could be set to operate in.

In a further aspect, the invention provides a method of assigning a frequency band of a mobile communications network to a user equipment, UE, device for communication with the network, the method comprising receiving charge status information of a rechargeable power supply from the UE device; and dependent on the charge status, assigning a frequency band having a lower attenuation coefficient than a second frequency band in which the UE device could be set to operate in.

In one aspect of the invention the battery status of the mobile device (UE) is determined and taken into consideration when selecting a frequency band for transmission of radio signals. The battery status information may consist for example of remaining battery capacity, an indication that the battery is currently charging, an indication that the device is connected to a fixed power supply, an indication, that the device is requiring a power saving communication mode (e.g. it is an ultra-low power device) and an indication that a high data rate is required, irrespective of the expected power consumption.

These pieces of information may be used to select a matching frequency band according to the frequency specific attenuation. I.e. a frequency band with a lower attenuation, if the remaining battery capacity is below a threshold or if a device requires a power saving communication mode, and a frequency band, which requires more transmission power but which will also provide a benefit e.g. a higher data rate, if a device requires a high data rate irrespective of the power demand.

The selection may either done by the mobile network, which will assign it to a UE for the next transmission, or it is done by the UE, which will use it directly for transmissions towards the mobile network.

The information of the battery status may be derived e.g. periodically or at connection setup or at certain events (if the level is below a threshold or if the charging cable is unplugged).

The frequency selection may be performed, for example, at connection setup and in cases when the battery status has changed.

Enabling the mobile network and the UE to use the battery status information from the UE to select a matching frequency band for upcoming or ongoing transmission will provide a power saving communication for UEs with limited power reserve and a data rate optimized communication mode, for UEs without power constraints.

The UE may be enabled to derive information of its own power supply and to transmit these information to the base station (gNB) of the mobile network prior or during a connection setup procedure.

Further, the UE may be enabled to determine the specific attenuation of the frequency bands provided by the gNB, e.g. in dB/km.

Further, the UE may be enabled to use the information of its own power supply for selecting a frequency band for transmissions towards a gNB. The gNB may be enabled to derive power supply information from the UE, e.g. percentage of remaining power or if the UE is connected to a power supply. Further, the gNB may be enabled to determine the specific attenuation of the provided frequency bands, e.g. in dB/km.

Even further, the gNB is enabled to select a frequency band for transmission according to the determined power supply information and the specific attenuations of the provided frequency bands. It considers this information when assigning radio resources, e.g. in case of low remaining battery capacity, it will assign resources that will require a lower transmit power due to a lower frequency specific attenuation and in case of high remaining battery capacity, or if the battery is currently charging, the gNB will assign a radio resource that may require a higher transmit power.

The gNB may consider further parameters for this selection, e.g. occupation level of the bands.

Further, the UE may be enabled to request a change of the frequency bands currently used by other UEs and to respond to such requests, if the change proposal is acceptable for the UE

Therefore, these methods will extend active time and idle time of mobile devices like smart phones or IoT devices like smart meters or sensors. Further, the UE and the mobile network will benefit from reduced interferences, if the power demand for transmission and reception is of less importance for the UE.

Preferred embodiments of the invention will now be described, by way of example only, with reference to the accompanying drawings in which:

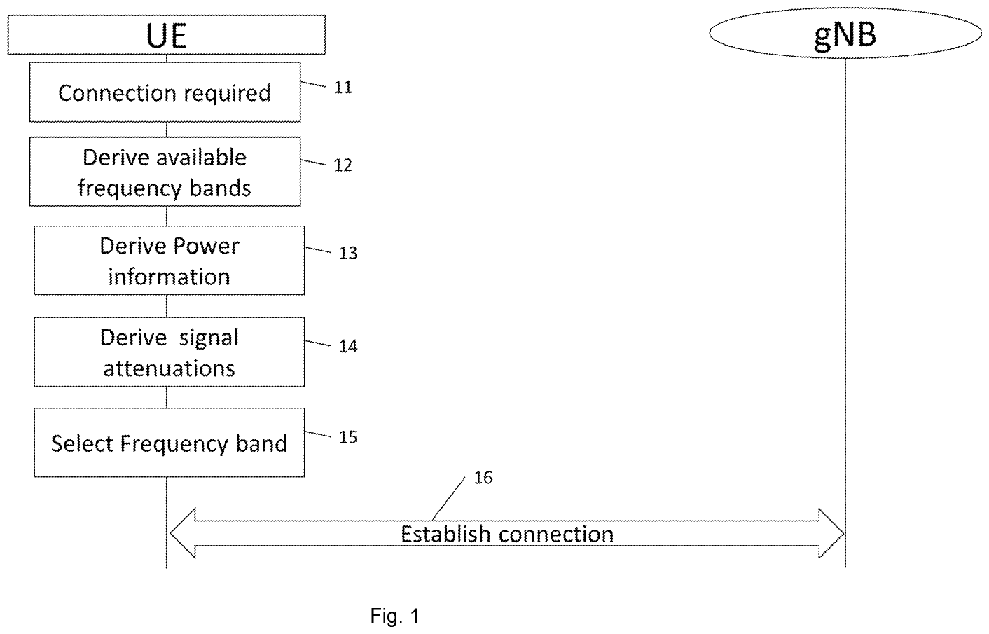

FIG. 1 shows steps performed in a first embodiment of the invention;

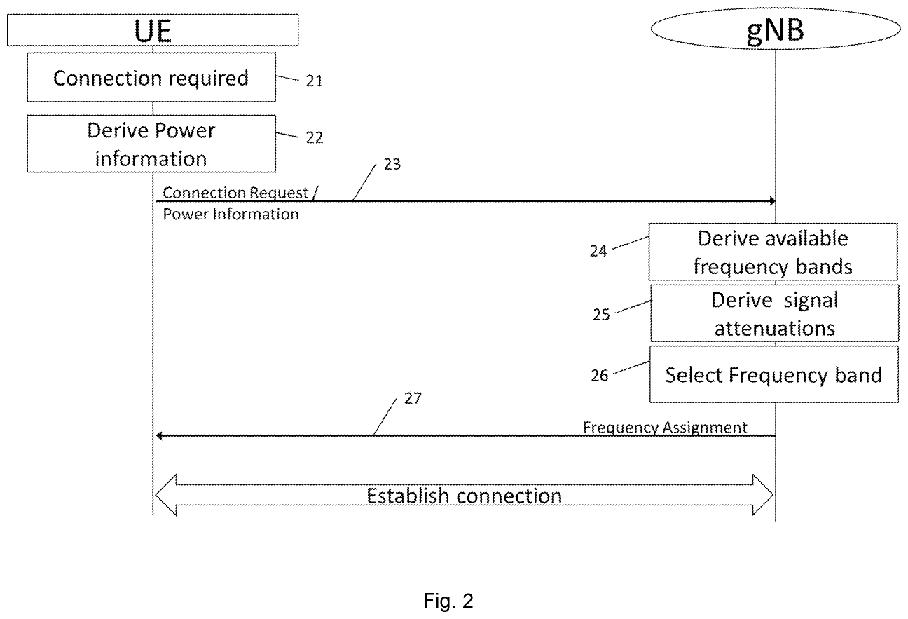

FIG. 2 shows steps performed in a second embodiment of the invention; and

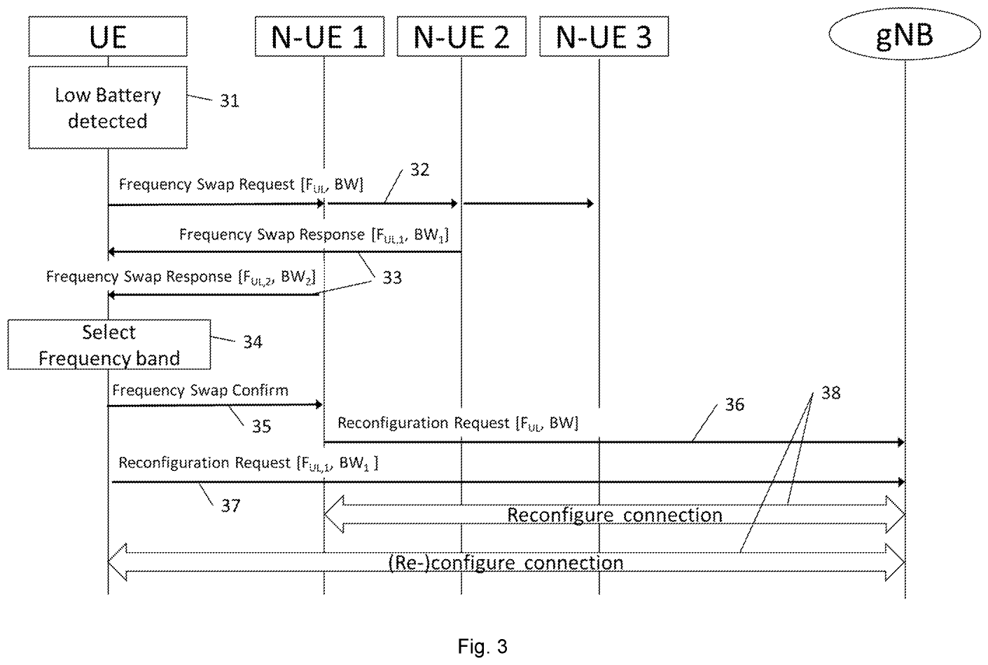

FIG. 3 shows steps performed in a third embodiment of the invention.

In the following, a communication system according to 5G is assumed. This type of system is selected as example to show the principles of the invention. The invention is not limited to a specific communication system; such as 5G. All kinds of communication systems like UMTS, HSPA, LTE, LTE Advanced, WiFi or future radio communication systems can also benefit from the described methods.

In a first embodiment, a UE is performing the frequency selection. The message flow is depicted in FIG. 1 and described in the following:

Step 11: The UE wants to establish a connection towards the gNB of the mobile network, e.g. due to a mobile originated data transfer.

Step 12: The UE derives available carrier frequencies for transmission. Available carrier frequencies may be stored in the UE or transmitted from the mobile network e.g. during a connection establishment performed previously or now. The mobile network could transmit a list of carrier frequencies, or it may broadcast downlink pilot signals on available frequencies.

In this example the UE has scanned the downlink previously from the gNB, and has derived that three frequencies are available (cf. table 1) Step 13: The UE derives power information from its own power supply. This may include at least one of

whether the battery is charging

a battery charge level

a preference of the device relating to power consumptions (e.g. power saving mode or high data rate mode)

In this example, the device is running on battery and requires an ultra-low power consumption.

Step 14: The UE derives the frequency specific attenuation of available frequencies. In this example, it uses previously stored data with the average attenuation in 1 kilometer distance for each relevant frequency band. The values for the currently available bands from the gNB are shown in table 1.

TABLE 1
Attenuation of the available frequency bands.

| Available | | Average Attenuation |
|---|---|---|
| Bands | Frequency Range | at 1 km distance |

| | | | |
|---|---|---|---|
| Band 1 | 1.920-2.010 | GHz | 100 dB |
| Band 2 | 24.24-27.50 | GHz | 120 dB |
| Band 3 | 60-70 | GHz | 200 dB |

Step 15: The UE selects one or more frequency bands according to the attenuation and the preference of the UE. In this example, the preferences require an ultra-low power consumption. Therefore, the UE selects band 1, as it has the lowest attenuation and therefore will require the lowest transmit power.

Step 16: The UE starts the transmission by using the selected frequency band.

In a further example, the UE derives available frequencies in step 12 from multiple gNBs. In this case, the UE will additionally consider the path loss for each gNB for the frequency selection. This is required, to obtain comparable values for the expected attenuations for different gNBs.

The UE will derive the path loss from the downlink signal of the respective gNB, derives the differences of the path loss with the average attenuation of the respective frequency from the stored data and adds this difference to the average attenuation of the available frequencies. This is done for each gNB in order to estimate the path loss for available frequencies. This piece of information is comparable between gNBs and can be used to select the frequency according to the path loss estimations and the power preferences.

This embodiment has the benefit that it enables the UE to save transmit power without any support by the network. This leads to a relatively simple implementation of the invention in commercial devices.

In a second embodiment, which is the preferred embodiment, frequency selection is performed by the mobile network. A flow chart is shown in FIG. 2 and described below.

Step 21: The UE wants to establish a connection towards the gNB of the mobile network, e.g. due to a mobile originated data transfer.

Step 22: The UE derives power information from its own power supply. In this example, the battery is currently charging. The service, that is requested by the user is an online gaming session, which will require highest data rate and lowest latency if battery status is above 50% or the battery is currently charging.

Step 23: The UE transmits a connection setup request to the gNB. The request includes the power information “charging” and the request for a high data rate at low latency.

Step 24: The gNB derives the available frequencies.

Step 25: The gNB derives the frequency specific signal attenuation. In this example, the available bands and the relating attenuations are listed in table 1.

Step 26: The gNB selects the frequencies for uplink and downlink transmissions. It prefers frequencies with a high available data rate. Band 3 from table 1 is selected, since band 3 provides high bandwidth with low interference.

Step 27: The selected frequency is assigned to UE by the serving gNB for connection establishment.

This embodiment has the benefit that it enables the network operator to assign frequency bands accordingly to power information from UEs. Therefore, mobile devices and mobile networks are more energy efficient. Idle and active time of mobile devices are extended. In addition, the mobile network can consider the current resource occupation, which leads to a fair and energy efficient distribution of the users to the available resources according to their needs and power conditions.

In a third embodiment, the UE negotiates the frequency bands with nearby other UEs. It may therefore use short range communication technologies like Bluetooth (r), WiFi, Zigbee etc., and the device-to-device communication of the cellular network (called sidelink or PC5 interface in LTE). Such negotiation may be performed prior or during a connection with the network. The flow chart for the negotiations is depicted in FIG. 3 and described below. For the sake of simplicity, only one uplink frequency band is negotiated. But the principle is also usable to negotiate multiple frequencies and multiple direction, e.g. uplink, downlink and sidelink:

Step 31: The UE's battery state falls below a threshold during an ongoing cellular connection. The currently used frequency band for uplink transmission F_{UL} is not optimal for power saving and the UE is aware (e.g. from received downlink signals), that also power saving frequencies are provided by the cellular network.

Step 32: The UE transmits a request message via a short range technology (PC5 interface in this example) as broadcast transmission to nearby UEs. This request is for a change of the used uplink frequency F_{UL} to an uplink frequency with a lower power requirement used by any nearby UE. Therefore the used uplink frequency and the currently assigned bandwidth BW are included in the request.

Step 33: Three neighboring UEs are currently available, N-UE 1 to N-UE 3. N-UE 1 is able and willing to swap frequencies, i.e. it currently uses a more power saving frequency band F_{UL,1} compared to F_{UL} as used by the UE, and it will benefit from the swap, as the bandwidth offered by the UE (BW) is larger compared to the currently used bandwidth (BM). Therefore it accepts the swap by transmission of a frequency swap response message, which includes the uplink frequency and bandwidth as currently used by N-UE 1. Also N-UE 2 accepts the request and responds with F_{UL,2} and BW₂. N-UE 3 has received the request, but is not willing or not able for the swap, e.g. because the offered bandwidth BW is not sufficient or it also requires a power saving uplink frequency. Therefore N-UE 3 does not send a response message. In this step, the respective users of the devices may be involved. E.g. the offer details are displayed and the users may accept or reject the offer.

Step 34: The UE selects the new UL frequency band from the received responses. The offer from N-UE 2 is not acceptable for the UE, e.g. as the bandwidth is too low. But the offer from N-UE 1 is acceptable.

Step 35: The UE accepts the offer from N-UE 1 by transmission of a frequency swap confirm message to N-UE 1.

Step 36: N-UE 1 inform the gNB about the reconfiguration by transmission of a reconfiguration request message to the gNB. Included are the new uplink frequency F_{UL} and bandwidth BW₁.

Step 37: The UE inform the gNB about the reconfiguration by transmission of a reconfiguration request message to the gNB. Included are the new uplink frequency F_{UL,1} and bandwidth BM.

Step 38: The gNB in this example reconfigure N-UE 1 and UE, i.e. it assigns F_{UL,1} and BM to UE and FUL and BW to N-UE 1. The gNB may also have the freedom to alter the proposed changes, e.g. to assign other frequencies or bandwidth than proposed, or to fully reject the reconfiguration requests.

From this embodiment, the connection of both UEs will benefit: the requesting UE will benefit from a reduced power consumption and the accepting UE will benefit from a higher bandwidth.

1. A method of selecting a frequency band of a mobile communications network in which a first user equipment, UE, device is to operate, the method comprising:
determining a charge status of a rechargeable power supply of the first UE device; and
dependent on the charge status, generating an indication that the first UE device should, taking into account the charge status, preferably be set to operate in a frequency band having a lower attenuation coefficient than a second frequency band in which the first UE device could be set to operate in.

2. The method according to claim 1, wherein the indication is generated only if operation in the second frequency band is not required in order for a required data transmission rate to be achieved.

3. The method according to claim 1, wherein the charge status is at least one of a remaining battery capacity, an indication that the power supply is being recharged, an indication that the first UE device is currently connected to an external power supply, an indication that the first UE device requires a power saving communication mode, and an indication that a communication at a data rate above a predetermined threshold is required.

4. The method according to claim 1, wherein the charge status is determined at a connection setup, periodically or in response to an occurrence of a predetermined event.

5. The method according to claim 1, wherein the indication is generated at a connection setup or following a change of charge status.

6. The method according to claim 1, wherein a selection of a frequency band in which the first UE device is to operate is performed by the mobile communications network in response to information received from the first UE device.

7. The method according to claim 1, wherein an attenuation coefficient for each possible frequency band is determined by the first UE device or by the mobile communications network.

8. A method of assigning a frequency band of a mobile communications network to a first user equipment, UE, device for communication with the network, the method comprising:
receiving charge status information of a rechargeable power supply from the first UE device; and
dependent on the charge status, assigning a frequency band having a lower attenuation coefficient than a second frequency band in which the first UE device could be set to operate in.

9. The method according to claim 8, wherein the charge status information is at least one of a remaining battery capacity, an indication that the power supply is being recharged, an indication that the first UE device is currently connected to an external power supply, an indication that the first UE device requires a power saving communication mode, and an indication that a communication at a data rate above a predetermined threshold is required.

10. The method according to claim 1, wherein following the generation of the indication, the first UE device transmits a message to one or more further UE devices to determine whether a frequency band with a lower attenuation coefficient currently being used by the one or more further UE devices could be made available for use by the first UE device.

11. The method according to claim 10, wherein a reconfiguration of the first UE device is performed by a base station following a notification that the one or more UE devices has agreed to the first UE device being assigned the frequency band with the lower attenuation coefficient.

12. The method according to claim 2, wherein the charge status is at least one of a remaining battery capacity, an indication that the power supply is being recharged, an indication that the first UE device is currently connected to an external power supply, an indication that the first UE device requires a power saving communication mode, and an indication that a communication at a data rate above a predetermined threshold is required.

13. The method according to claim 2, wherein the charge status is determined at a connection setup, periodically or in response to an occurrence of a predetermined event.

14. The method according to claim 2, wherein the indication is generated at a connection setup or following a change of charge status.

15. The method according to claim 2, wherein a selection of a frequency band in which the first UE device is to operate is performed by the mobile communications network in response to information received from the first UE device.

16. The method according to claim 2, wherein an attenuation coefficient for each possible frequency band is determined by the first UE device or by the mobile communications network.

17. The method according to claim 3, wherein the charge status is determined at a connection setup, periodically or in response to an occurrence of a predetermined event.

18. The method according to claim 3, wherein the indication is generated at a connection setup or following a change of charge status.

19. The method according to claim 3, wherein a selection of a frequency band in which the first UE device is to operate is performed by the mobile communications network in response to information received from the first UE device.

20. The method according to claim 3, wherein an attenuation coefficient for each possible frequency band is determined by the first UE device or by the mobile communications network.
